(19) United States
(12) Patent Application Publication
(10) Pub. No.: US 2007/0092438 A1
(43) Pub. Date: Apr. 26, 2007

(54) Process and Apparatus for Producing a Gas from Hydrates

(76) Inventor: Richard Mark Godfrey, West Perth (AU)

Correspondence Address: EDELL, SHAPIRO & FINNAN, LLC, 1901 RESEARCH BOULEVARD, SUITE 400, ROCKVILLE, MD, 20850, US

(21) Appl. No.: 11/536,789

(22) Filed: Sep. 29, 2006

Related U.S. Application Data
(63) Continuation of application No. PCT/AU04/00715, filed on May 31, 2004.

(51) Int. Cl. C01B 3/00

(52) U.S. Cl. 423/658.2

(57) ABSTRACT

A process and apparatus for producing a gas at a pre-set delivery pressure are described. Using the process, hydrates and a liquid are introduced to a vessel to at least partially fill the vessel. The liquid must have a freezing point lower than the hydrate dissolution temperature to avoid freezing of the liquid when it comes into contact with the hydrates. The vessel is sealed against release of gas from the vessel before dissolving at least a portion of the hydrates to produce liberated gas and free water. When the operating pressure of the vessel is at or above the pre-set delivery pressure, the liberated gas is released at the pre-set delivery pressure and may be subjected to further conditioning before delivery to an end user.

### CROSS REFERENCE TO RELATED APPLICATION

This application is a continuation of PCT/AU2004/000715, filed May 31, 2004, and titled “A Process and Apparatus for Producing a Gas From Hydrates,” the entire contents of which are hereby incorporated by reference.

### FIELD

The present invention relates to a process and apparatus for producing a gas at a pre-set delivery pressure by dissolving hydrates.

One gas hydrate of particular commercial interest is natural gas and the present invention relates particularly, though not exclusively, to a process and apparatus for producing natural gas at a pre-set delivery pressure by dissolving hydrates.

### BACKGROUND

Gas hydrates or clathrates are ice-like solids which form from a mixture of water and gas under conditions of elevated pressure and reduced temperature. The water molecules form a crystal lattice structure resembling a cage within which molecules of the gas become trapped. For any given crystal lattice structure there is a theoretical maximum amount of gas that may be trapped within the lattice, known in the art as the “maximum gas content” or “theoretical energy density” of the hydrate.

When the temperature is raised above the so-called “hydrate dissolution temperature”, the hydrates dissolve, liberating the trapped gas and converting the crystal lattice to “free water”.

Natural gas is a mixture of gaseous hydrocarbons that occurs in nature, typically in association with oil reservoirs. It main component is methane with varying amounts of ethane, propane and butane usually present along with trace amounts of carbon dioxide, hydrogen sulphide, and nitrogen. Natural gas has been found to occur in nature in hydrate form in some deep-sea environments. Natural gas hydrates are typically stable at temperatures at or below −15° C. at atmospheric pressure and have a maximum gas content of around 180 Sm³ of gas/m³ of hydrate for known lattice structures.

Synthetic natural gas hydrates have been produced under laboratory conditions with higher gas contents. The applicant's International Application No. PCT/AU00/00719 (Jackson et al), the contents of which are incorporated herein by reference, described the production of synthetic natural gas hydrate having a gas content in excess of 180 Sm³/m³ and as high as 227 Sm³/m³. The synthetic natural gas hydrates had a hydrate dissolution temperature greater than 0° C. at atmospheric pressure and were produced using a mixture of gas, water and an additive adapted to reduce interfacial tension.

Attempts have been made to capitalise on the high gas contents of hydrates in energy-related applications. Known regasification techniques utilise heating of the hydrate to liberate the trapped gas at atmospheric or low pressure conditions. Such conventional processes result in the production of a gas at pressures just above atmospheric pressure, typically 120 kPa. This pressure is well below the theoretical level of pressure able to be generated for a hydrate of a given gas content dissolved in a vessel of fixed volume. Moreover, typical pipeline applications supplying gas-fired power stations operate at around 40 Mpa pressure. Thus, using known techniques for regasification of hydrates, the gas must be subjected to costly gas compression processes before delivery to the end user. Compression of the gas involves the consumption of considerable amounts of energy leading to high operational expenses. Added to this, the installation of compression plants requires significant capital expenditure.

There is a need for a process that is better able to capitalise on the relatively high amount of gas stored in the crystal structure of hydrates.

It will be clearly understood that, although prior art use and publications are referred to herein, this reference does not constitute an admission that any of these form a part of the common general knowledge in the art, in Australia or in any other country.

In the statement of invention, the description of the invention and the claims which follow, except where the context requires otherwise due to express language or necessary implication, the word “comprise” or variations such as “comprises” or “comprising” is used in an inclusive sense, i.e. to specify the presence of the stated features, but not to preclude the presence or addition of further features in various embodiments of the invention.

### SUMMARY OF THE INVENTION

According to one aspect of the present invention, there is provided a process for producing a gas at a pre-set delivery pressure, the process comprising the steps of:

introducing hydrates and a liquid to a vessel to at least partially fill the vessel, the liquid having a freezing point lower than the hydrate dissolution temperature;

sealing the vessel against release of gas from the vessel;

thereafter dissolving at least a portion of the hydrates to produce liberated gas and free water; and,

releasing the liberated gas from the vessel when the operating pressure of the vessel is at or above the pre-set delivery pressure.

The process utilises the relatively low energy associated with the pumping of a liquid instead of the higher energy associated with the compression of a gas. The liquid is introduced to the vessel so as to fill voids between the hydrates and the walls of the vessel, between individual hydrates and adjacent hydrates and/or at least a portion of the dead space above the level to which the vessel is at least partially filled. Voids may also be present within the hydrate crystal structure itself and it is understood that the operating pressure is sufficiently high that the liquid also fills these intercrystalline voids. Using conventional hydrate regasification techniques, the liberated gas must first fill these voids before any increase in the operating pressure of the vessel is observed. The process of the present invention overcomes this problem by effectively pre-filling the voids with the liquid.

The step of sealing the vessel may occur prior to, during or after the step of introducing hydrates and a liquid to the vessel. Additional liquid may be introduced to the vessel so as to substantially fill the vessel.

In one embodiment, the hydrate and liquid are introduced to the vessel in the form of a slurry. The use of a slurry allows the process to be run on a continuous basis due to the ability to pump slurry into the vessel whilst the vessel is operating under pressure.

The step of dissolving at least a portion of the hydrates may comprise the step of heating the hydrates to a temperature greater than the hydrate dissolution temperature.

The hydrates may be heated by introducing the liquid to the vessel at a temperature greater than the hydrate dissolution temperature so as to dissolve at least a portion of the hydrate. Alternatively or additionally, the hydrates may be heated by heating the vessel internally and/or externally.

The process may further comprise the step of pre-heating the liquid or slurry prior to the step of introducing the liquid or slurry to the vessel.

The liquid should be pH neutral to minimise the service life of process equipment. It is advantageous for the liquid to have a specific gravity at least 20% greater than that of the hydrate and/or for the liquid to be insoluable in water to facilitate separation of the liquid from water if desired.

The liquid introduced to the vessel or used to form the slurry may be water, condensate, LPG, or a combination thereof. These liquids may have a different composition.

In one embodiment, the process further comprises a shut-down sequence including the step of filling the vessel with the liquid so as to displace liberated gas from the vessel whilst maintaining the operating pressure of the vessel at or above the pre-set delivery pressure.

When a slurry is used, the process may be operated on a continuous basis by balancing the supply of slurry to the vessel with the removal of released liberated gas, liquid and free water from the vessel so as to maintain the operating pressure of the vessel at the pre-set delivery pressure.

The gas released from the vessel may require conditioning to meet end user product specifications. To this end, the process may further comprise the step of conditioning the removed gas by adjusting the temperature of the released gas. Alternatively or additionally, the released gas may be conditioned by separating excess water from the released gas.

The released gas is supersaturated for liquid and/or slurry-forming liquid. The process may further comprise the step of separating excess liquid and/or slurry-forming liquid from the released gas. At least a portion of the separated excess liquid and/or slurry-forming liquid may be recycled.

The process further comprises the step of agitating the hydrates in the vessel. In one embodiment, this is achieved by introducing the liquid tangentially to the vessel so as to create a vortex.

The process may further comprise the step of removing a mixture of free water, liquid and/or slurry-forming liquid from the vessel In one embodiment, the gas is recovered by reducing the pressure of the mixture so as to produce a supersaturated mixture and subjecting the supersaturated mixture and hereafter separating gas from the supersaturated mixture. The process may further comprise the step of compressing the separated gas to the pre-set delivery pressure for delivery to an end user.

According to a second aspect of the present invention, there is provided an apparatus for producing a gas at a pre-set delivery pressure, the apparatus comprising:

a sealable vessel for receiving hydrates;

a liquid inlet for introducing a liquid to the sealable vessel;

a means for dissolving at least a portion of the hydrates; and,

a gas outlet arranged to release the liberated gas from the vessel when the operating pressure of the vessel is at or above the pre-set delivery pressure.

The apparatus may further comprise a slurry inlet for receiving a slurry, the slurry comprising a slurry-forming liquid and hydrates.

In one embodiment, the means for dissolving at least a portion of the hydrates is a means for heating the hydrates to a temperature greater than the hydrate dissolution temperature. The means for heating the hydrates may be a heating unit internal or external to the vessel.

The apparatus may equally comprise a plurality of sealable vessels operating in series or parallel so as to produce a substantially continuous supply of gas at the pre-set delivery pressure.

In one embodiment, the apparatus further comprises a first controller for balancing the supply of slurry to the vessel with the removal of liberated gas, slurry-forming liquid, liquid and/or free water from the vessel. Alternatively or additionally, the apparatus further comprises a second controller for balancing the supply of slurry to the vessel with the rate of removal of liberated gas from the vessel so as to maintain the operating pressure of the vessel at the pre-set delivery pressure.

The apparatus may include a gas conditioning unit arranged to adjust the temperature of the liberated gas. The gas conditioning unit may further comprise a means for drying the released gas.

In one embodiment, a gas/liquid separator is used for separating excess water, liquid and/or slurry forming liquid from the removed gas.

The apparatus further comprises an agitator for agitating the hydrates in the vessel. In one embodiment, the liquid inlet is tangential to the vessel to create a vortex.

The apparatus may further comprise a gas recovery unit for recovering gas from a mixture of free water, liquid and/or slurry-forming liquid drained from the vessel. Preferably, the gas recovery unit comprises one or more condensers for reducing the pressure of the recovered gas and produce a supersaturated gas. The gas recovery unit may further comprise one or more gas/liquid separators for separating gas from the supersaturated gas and may further comprise one or more compressors for compressing the separated gas so as to increase the pressure of the separated gas.

### BRIEF DESCRIPTION OF THE DRAWINGS

Embodiments of the present invention will now the described, by way of example only, with reference to the accompanying drawings, in which:

FIG. 1 illustrates a process flow chart for a first embodiment of the present invention for producing gas at a pre-set delivery pressure using solid hydrate in a batch process;

FIG. 2 illustrates a process flowsheet for a second embodiment of the present invention for producing gas at a pre-set delivery pressure using a slurry in a continuous process; and,

FIG. 3 illustrates schematically a third embodiment of the present invention incorporating a gas conditioning and recovery system.

### DESCRIPTION OF THE EMBODIMENTS

Before the embodiments of the process and apparatus for producing gas at a pre-set supply pressure from hydrates are described, it is to be understood that the various aspects of the present invention are not limited to the particular sequence of steps, operating pressures and temperatures, nor the particular arrangement of the vessels described. The terminology used herein is for the purpose of describing particular embodiments only, and is not intended to limit the scope of the present invention in any way which is limited only by the claims. Unless defined otherwise, all technical and scientific terms used herein have the same meanings as commonly understood by one of ordinary skill in the field to which this invention belongs.

Although other types of processes and apparatus similar to or equivalent to those described herein can be used to practice or test the various aspects of the present invention, specific embodiments of apparatus and sequence of steps are now described with reference to the dissolution of natural gas hydrates to produce natural gas at a pre-set supply pressure.

Although the embodiments are directed towards dissolving natural gas hydrates so as to produce natural gas, hydrates of other gases such as methane and CO₂ may equally be subjected to the same process. Any hydrate is expected to store and release gas in a similar fashion.

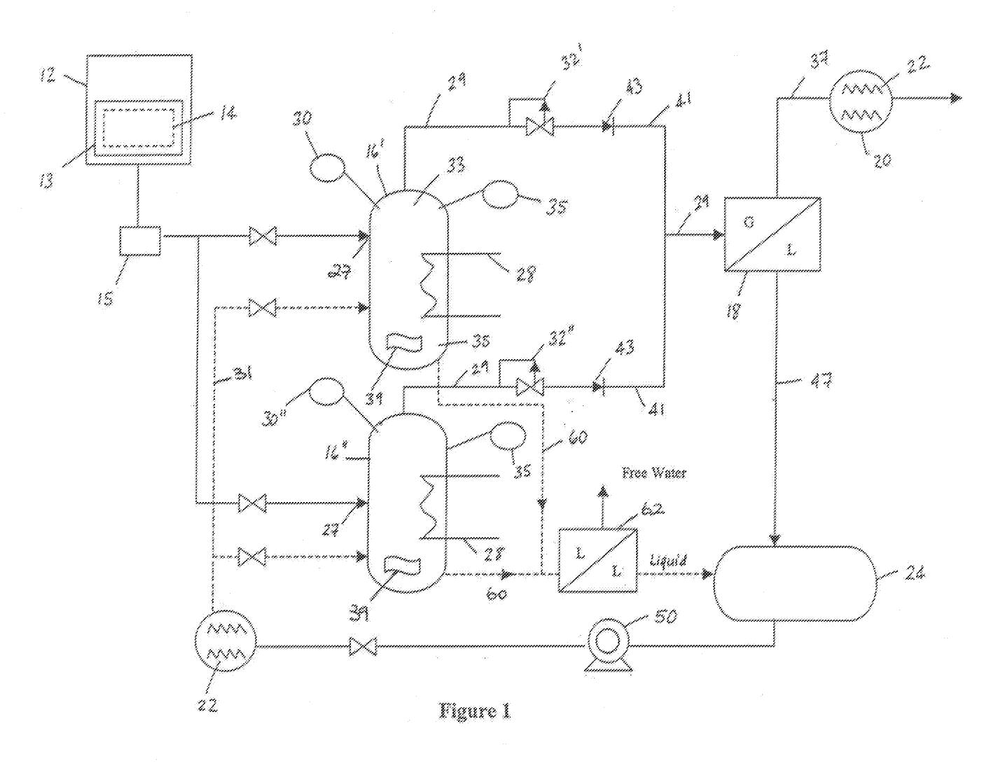

A first embodiment of the present invention is illustrated in the process flow sheet of FIG. 1. In this embodiment, hydrates are supplied in solid form and the process is conducted as a batch process.

With reference to FIG. 1, there is provided an apparatus for producing a gas 10 comprising a storage tank 12 for storing natural gas hydrates in solid form at atmospheric pressure and a temperature of around −15° C. For other types of hydrates, the pressure and temperature conditions of the storage tank 12 may need to be adjusted, the only requirement being that dissolution of the hydrates in the storage tank 12 is discouraged. The particular temperature of the storage tank 12 thus depends on the hydrate dissolution temperature of the particular hydrate for a given pressure. With reference to International Application No. PCT/AU00/00719, when an additive to reduce interfacial tension is mixed with water and gas to produce synthetic natural gas hydrate, the hydrate dissolution temperature may be greater than zero at atmospheric pressure.

As hydrates are highly adhesive to surfaces, the hydrates may adhere to the wall(s) 13 of the storage tank 12 leading to potential blockages. The storage tank 12 of FIG. 1 includes a flexible wall lining system 14 as described in the Applicant's co-pending International Application No. PCT/AU2004/000521 entitled “A non-adhesive wall lining system”, the contents of which are incorporated herein by reference. Hydrates that adhere to the wall(s) 13 of the storage tank 12 can be broken off by causing deformation of the flexible wall lining system 14 in the manner described in PCT/AU2004/000521.

Hydrates from the storage tank 12 are introduced to one or more pressure vessel(s) 16 so as to at least partially fill the vessel 16 with hydrate. It is to be clearly understood that the pressure vessels 16 may equally be used either in series or parallel to produce gas at the pre-set supply pressure. In the embodiment illustrated in FIG. 1, two pressure vessels 16′ and 16″ are used.

The hydrate is transferred from the storage tank 12 to the pressure vessel(s) 16 using any suitable transfer means 15, in this example a flat or screw conveyor, until the pressure vessel 16 has been at least partially filled with hydrate, typically 60 to 90% by volume and preferably 65 to 75% by volume.

Each pressure vessel 16 is provided with a gas outlet valve 32 that is used to seal the vessel until the operating pressure within the vessel is at or above the pre-set delivery pressure. In this example, the gas outlet valve 32 comprises a pressure relief valve set at the pre-set delivery pressure with an optional non-return valve 43 positioned downstream of the vessel 16 in a conduit 41. The gas outlet valve 32 may equally be a simple valve co-operating with a pressure sensor (not shown).

The gas outlet valve 32 must be closed so as to seal the vessel prior to the step of dissolving at least a portion of the hydrates. It may be open or closed during the steps of introducing hydrate to the vessel 16 and/or the step of introducing a liquid to the vessel.

In the first embodiment of the present invention, a liquid 31 is pumped into the vessel(s) 16 from a buffer tank 24. The liquid 31 must have a freezing point less than the hydrate dissolution temperature to avoid freezing of the liquid 31 in the vessel 16. The liquid 31 may be pre-heated using any suitable heating unit 22. In this example, the heating unit 22 is a simple hot water jacket utilising low-grade waste heat from other process equipment (not shown). Preheating the liquid 31 reduces the level of direct heating of the vessel 16 required to dissolve the hydrates. Preheating the liquid 31 also mitigates the risk of the liquid 31 freezing upon contact with the hydrates.

In this embodiment, each pressure vessel 16 is provided with a level indicator 30 to monitor the level of the liquid 31 and/or hydrate added to the vessel 16. Sufficient liquid 31 may be added to the vessel 16 so as to substantially fill the vessel and remove dead space above the solid hydrates. It is to be understood that the liquid 31 need not fill the vessel 16, it being preferable that sufficient liquid 31 be added so as to at least cover the hydrates.

When sufficient liquid 31 has been introduced to the vessel 16 and the gas outlet valve 32 has been closed, at least a portion of the hydrates is dissolved so as to liberate gas and free water therefrom. Dissolution of the hydrates is achieved by heating the hydrates to a temperature at or above the hydrate dissolution temperature for the given operating pressure of the vessel 16. As the hydrates dissolve, the gas trapped within the crystal lattice structure is liberated and free water is released. The liberated gas has a low relative density and therefore rises towards an uppermost portion 33 of the vessel 16. The more dense free water descends under gravity along with the liquid 31 towards a lowermost portion 35 of the vessel 16.

The operating pressure of each vessel 16 is monitored using a pressure sensor 35. Because the vessel 16 is sealed and the liquid 31 has been added to fill voids within and between the solid hydrates, the operating pressure of the sealed vessel continuously increases as more of the hydrates dissolve. When the operating pressure within the vessel 16 is at or above the pre-set delivery pressure, the gas outlet valve 32 opens to release a gas stream 29 at the pre-set delivery pressure from the vessel 16. The gas stream 29 is supersaturated with respect to the liquid 31 and typically has the appearance of a mist. The term “supersaturated” is used here to indicate that two phases i.e. a gas phase and a liquid phase are present.

The supersaturated gas stream 29 passes along the conduit 41 and can either delivered to an end-user as is or subjected to further conditioning in the manner described below. Liquid 31 can be separated from the supersaturated gas stream 29 using any suitable gas/liquid separator 18 such as a cyclone separator, a knockout pot, a flash drum or the like. An unsaturated gas stream 37 is removed from the gas/liquid separator 18 for delivery to an end-user or further conditioning. A stream of separated excess liquid 47 is removed from the gas/liquid separator 18 and returned to the buffer tank 24 for re-use.

For most application specific product delivery specifications will need to be met in order to supply the gas produced by the process of the present invention to an end-user. One such product specification is the temperature of delivery of the gas. If required, the unsaturated gas stream 37 may be fed to a gas conditioning unit 20 provided with a temperature adjustment means 22. The temperature of the unsaturated gas stream 37 is adjusted by heating or cooling the gas stream 37 using the temperature adjustment means 22. The temperature adjustment means 22 may be a heating unit or cooling unit as required.

In order to provide a substantially continuous supply of gas, use of the apparatus 10 as illustrated in FIG. 1 is now described using a first and a second pressure vessel 16′ and 16″, respectively, operated in sequence. The second pressure vessel 16″ operates in the same way as the first. Filling of the second vessel 16″ with hydrate is timed to occur while the first vessel 16′ is being filled with liquid 31 to remove residual gas in the manner outlined below. Any number of vessels 16 could equally be used in series and/or in parallel to achieve a similar result.

Hydrate in solid form is transported from the hydrate storage vessel 12 into the first vessel 16′. When the signal from the level indicator 30′ indicates that the first vessel 16′ has been filled with solid hydrate to a desired level, the first vessel 16′ is sealed by closing corresponding gas outlet valve 32′ of vessel 16′.

Liquid 31 is then added to the first pressure vessel 16′ until the signal from the level indicator 30′ indicates that the level of the liquid 31 is at least that of the level of the solid hydrate supplied to the first vessel 16′. During the step of introducing the liquid to the vessel, any voids between the solid hydrates, between the solid hydrates and the walls of the vessel 16′, as well as any intercrystalline voids in the solid hydrates themselves, are filled with liquid 31.

The liquid 31 is pre-heated using heater 22 to a temperature below the hydrate dissolution temperature. It is also possible to introduce the liquid 31 to the first vessel 16′ at a temperature above the hydrate dissolution temperature provided that the vessel has been sealed prior to the liquid being introduced. Direct heat is applied to the first pressure vessel 16′ using an optional hot water circuit 28, arranged around an inside wall of the first vessel 16′. The hydrate/liquid mixture in the vessel 16′ is in this way heated to a temperature at or above the hydrate dissolution temperature.

It is understood that not all of the hydrates begin to dissolve at the same time and it is to be understood that there is no requirement that all of the hydrates within the vessel 16′ be caused to dissolve using the process of the present invention. To facilitate more even heating of the hydrates, the hydrate/liquid mixture in the first vessel 16′ is agitated using a mechanical agitator within the vessel 39. To assist in agitating the hydrate/liquid mixture by creating a vortex, the liquid 31 is introduced to the first vessel 16′ via a tangential inlet 27.

The gas liberated from the hydrates rises towards the uppermost portion 33 of the vessel 16′. The free water released from the hydrates migrates under gravity towards the lowermost portion 35 of the vessel 16′. As more and more of the hydrates are caused to dissolve, the pressure rises in the sealed vessel 16′. The operating pressure of the pressure vessel 16′ is monitored on a continuous basis. When the operating pressure of the pressure vessel 16′ exceeds the pre-set delivery pressure, the control valve 32′ of the first pressure vessel 16′ is opened to release the gas from the first pressure vessel 16′ at the pre-set delivery pressure.

When all of the hydrate has been dissolved, release of gas from the pressure vessel 16′ naturally comes to a stop. When this happens, the operating pressure of the first vessel 16′ is still at least equal to the pre-set delivery pressure and the vessel 16′ contains a mixture free water and liquid as well as a quantity of residual gas.

The residual gas can be evacuated from the vessel 16′ by using a high pressure evacuation pump 50 to introduce additional liquid 31 from the buffer tank 24. The additional liquid 31 is added so as to displace the residual gas from the vessel 16′. Thereafter, shutting the gas outlet valve 32′ isolates the first vessel 16′. A mixture 60 of liquid and free water remaining in the first vessel 16′ is then blown down, drawn down or drained from the first vessel 16′ into the buffer tank 24 for re-use. The liquid and free water may be separated from each other using any suitable liquid/liquid separator 62 and this is made easier if the liquid is insoluble in water and/or has a relative density that differs from water, say, by 20%.

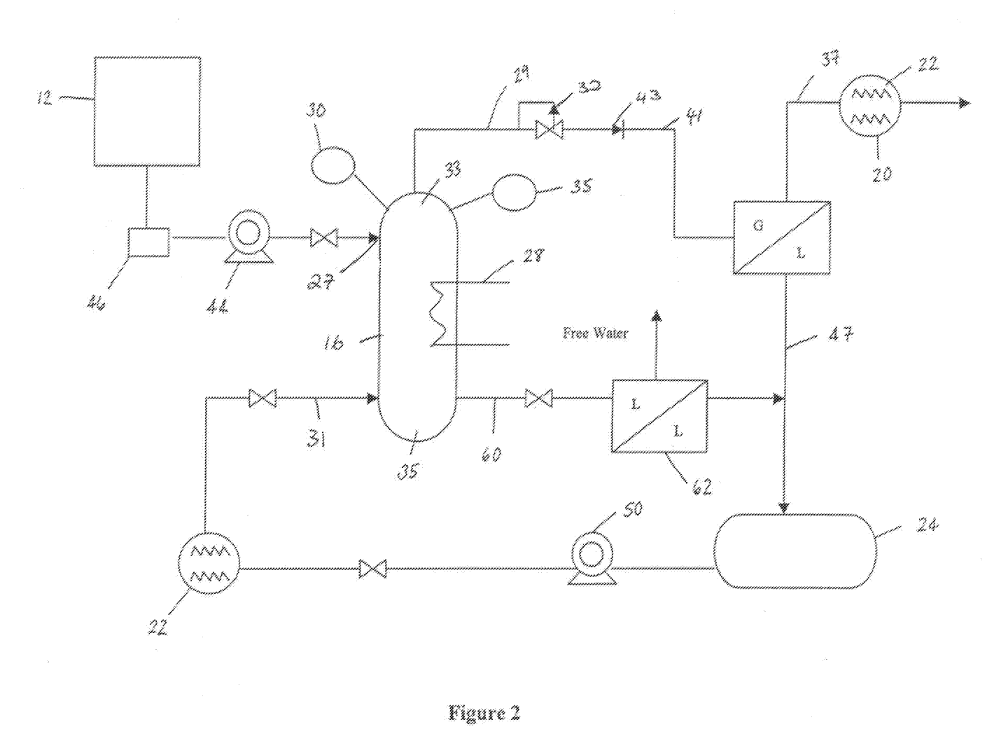

A second embodiment of the present invention is illustrated in FIG. 2 for which like reference numerals refer to like parts. In this embodiment, the hydrates are supplied to the vessel 16 as a slurry comprising solid hydrate and a slurry-forming liquid. The slurry-forming liquid may or may not be same type of liquid as the liquid 31 that is later introduced to the vessel 16 from the buffer tank 24. Suitable liquids include water, condensate, LPG or combinations thereof.

Using a slurry allows for the process to be conducted on a continuous basis after start-up. It is the ability to pump slurry into the vessel under pressure that allows for the process to be run on a continuous basis. The start-up sequence is effectively the same as that described in relation to the first embodiment. Thereafter, to operate the process on a continuous basis the level of the slurry within the vessel 16 is controlled so to maintain the operating pressure of the pressure vessel 16 at the pre-set delivery pressure. This is achieved by balancing the supply of slurry to the vessel 16 with the removal of slurry-forming liquid, liquid and/or free water from the vessel. The supply of slurry to the vessel 16 is also balanced against the rate of release of the liberated gas from the vessel so as to maintain the operating pressure of the vessel at or above the pre-set delivery pressure.

Without wishing to be bound by theory, it is understood that when the slurry is formed, the slurry-forming liquid fills at least some of the intercyrstalline voids within the hydrate lattice, as well as filling the voids between the hydrates. In the first embodiment, the liquid 31 introduced to the vessel 16 served this same function. In effect, then, by introducing the slurry to the vessel 16 using a slurry pump 44 or other suitable transfer means, hydrates and liquid are being added to the vessel 16 simultaneously.

As for the first embodiment, a level indicator 30 is used to indicate the level of the slurry in the vessel 16. During the start up sequence, the vessel 16 is at least partially filled with slurry and sealed by closing the gas outlet valve 32. As for the first embodiment, the gas outlet valve 32 may be closed before, during or after the step of at least partially filling the vessel 16 with slurry provided only that the vessel 16 is sealed before the step of dissolving the hydrates. The gas outlet valve 32 remains closed until such time as the operating pressure of the vessel 16 exceeds the pre-set delivery pressure. At that time, a stream of supersaturated gas 29 is released from the vessel 16.

The slurry may be pre-heated using any suitable heating means, in this example, a hot water circuit 46, provided that the temperature to which the slurry is pre-heated is at all times below the hydrate dissolution temperature so as to maintain stability of the hydrates in the slurry.

A mixture 60 of free water and slurry-forming liquid is removed from the lowermost portion 35 of the vessel 16 and may be separated from each other using liquid/liquid separator 62 for recycle and re-use.

To this end, it is advantageous for the slurry-forming liquid to have a relative density at least 20% higher or lower than water. The supersaturated gas stream 29 in this embodiment is supersaturated with respect to the slurry-forming liquid. This excess slurry-forming liquid can be separated and recycled in the same manner as described above in relation to the separation and recycling of excess liquid 31 for the first embodiment. Similarly, the unsaturated gas 37 may be conditioned if required in the manner described above to meet product delivery specifications

Should the continuous process needs to be shut down for any reason, for example, for maintenance, the supply of slurry to the vessel 16 is stopped and removal of the mixture 60 of slurry-forming liquid and free water from the lowermost portion 35 of the vessel 16 is ceased. The gas outlet valve 32 remains open while the residual gas remaining in the vessel 16 is expelled by filling the pressure vessel 16 with slurry-forming liquid from the buffer tank 24. After the residual gas has been expelled from the vessel, the gas outlet valve 32 is closed and any remaining mixture 60 can be drained or blown down from the vessel 16.

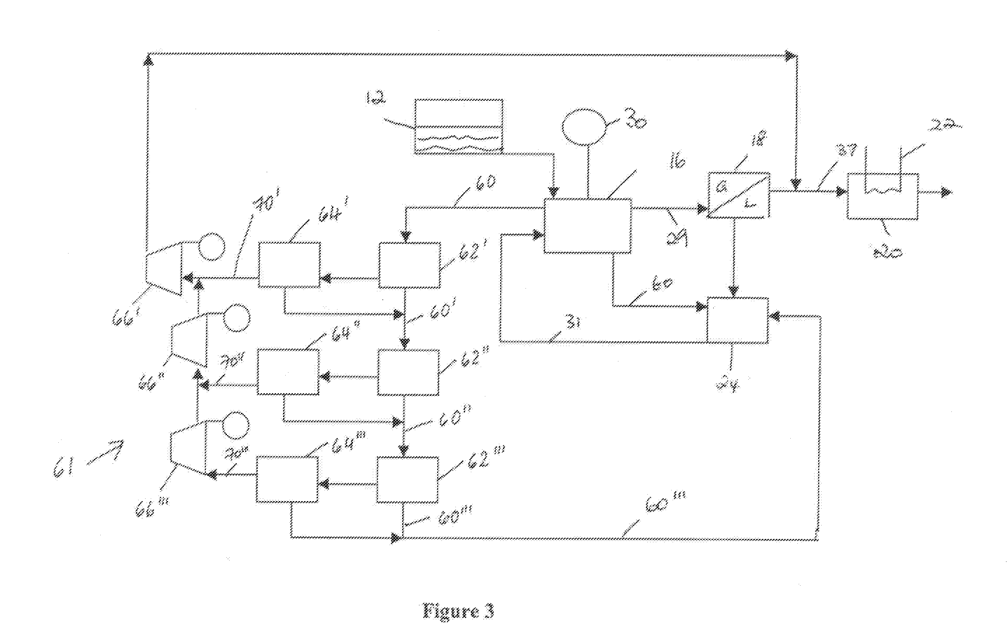

A gas recovery process for use in combination with the process of the present invention is illustrated in FIG. 3. The gas recovery process is used to recover gas from the mixture 60. For the purposes of the discussion to follow, the gas recovery process is described with reference to the first embodiment of the present invention. In that embodiment a mixture 60 of free water and liquid 31 is drained from the vessel 16 as one step in the shut-down sequence. The mixture 60 is saturated with gas at the operating pressure of the vessel 16. The gas is recovered from the mixture 60 using a gas recovery system 61 comprising a series of intermediate flash vessels 62′, 62″ and 62′″ in combination with a series of gas/liquid separators 64′, 64″ and 64′″.

The mixture 60 is fed to a first flash vessel 62′ in which the pressure is reduced to a first level of pressure that is intermediate between the operating pressure of the vessel 16 at shut down, and the pressure in the buffer tank 24 which is, typically, atmospheric pressure. As the pressure drops, the mixture 60 becomes supersaturated with gas and liquid and excess gas and liquid are separated from the mixture 60 using a first gas/liquid separation vessel 64′. Excess liquid 60′ at the first level of pressure is directed to the second flash vessel 62″. Excess gas 70′ is fed to compressor 66′ to restore the gas to pre-set delivery pressure. The excess gas 70′ may then be added to the unsaturated gas stream 37 fed to the gas conditioning unit 20.

The pressure of the mixture 60′ is further reduced in the second flash vessel 62″ to a second level of pressure, that is below the first level of pressure but above atmospheric pressure. The mixture 60′ again becomes supersaturated with gas and liquid due to the drop in pressure and is fed to a second gas/liquid separation unit 64″. Excess liquid and free water 60″ that is removed in the second gas/liquid separator 64″ is directed to a third flash vessel 62′″. Excess gas 70″ that has been separated using the second gas/liquid separator 64″ is compressed from the second level of pressure to the first level of pressure using second compressor 66″. Excess gas 70″ is then further compressed to the pre-set delivery pressure using the first compressor 66′.

Similarly the third flash vessels 62′″ is used to reduce the pressure of the mixture 60″ to atmospheric pressure. Excess gas 70′″ separated in the third gas/liquid separator 64′″ is compressed to the second level of pressure using the third compressor 66′″ and thereafter compressed to the pre-set delivery pressure using the second and first compressors, 66″ and 66′ respectively.

Any remaining liquid 60′″ is recycled to the buffer tank 24. When the liquid 31 is not water, further separation of the liquid 31 and the free water may be required prior to recycle of liquid 60′″ to the buffer tank 24.

The mixture 60 may equally be flashed to atmospheric pressure using a single flash tank. It is to be understood that the specific number of flash tanks and compressors may vary. The benefit of using a multi-stage flash tank and compressor system as described above is that each compressor and flash tank may be smaller and thus cheaper than using a single flash tank and compressor system. Similarly, each of the compressors 66′, 66″ and 66′″ will have a lower duty than would be required for a single compressor to take the released saturated gas from atmospheric pressure back up to line pressure.

Now that the embodiments of the present invention have been described in detail, the present invention has a number of advantages over the prior art, including:

(a) the process may be operated on a continuous basis using a single pressure vessel;

(b) between 70 and 100% of compression power requirements may be saved over prior art processes by optimising the high gas content of the hydrate itself;

(c) a slurry pump is used instead of costlier gas compression equipment; and,

(d) costs are reduced by utilising low grade heat to help dissolve the hydrates.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description and the appended claims.

1. A process for producing a gas at a pre-set delivery pressure, the process comprising the steps of:
introducing hydrates and a liquid to a vessel to at least partially fill the vessel, the liquid having a freezing point lower than the hydrate dissolution temperature;
sealing the vessel against release of gas from the vessel;
thereafter dissolving at least a portion of the hydrates to produce liberated gas and free water; and,
releasing the liberated gas from the vessel when the operating pressure of the vessel is at or above the pre-set delivery pressure.

2. The process of claim 1, wherein the step of sealing the vessel occurs prior to, during or after the step of introducing hydrates and a liquid to the vessel.

3. The process of claim 1, wherein additional liquid is introduced to the vessel so as to substantially fill the vessel.

4. The process of claim 2, wherein the hydrate and liquid are pre-mixed and added to the vessel in the form of a slurry.

5. The process of claim 1, wherein the step of dissolving at least a portion of the hydrates comprises the step of heating the hydrates to a temperature greater than the hydrate dissolution temperature.

6. The process of claim 5, wherein the step of heating the hydrates comprises the step of introducing the liquid at a temperature greater than the hydrate dissolution temperature so as to dissolve at least a portion of the hydrate.

7. The process of claim 5, wherein the step of heating the hydrates further comprises the step of heating the vessel internally and/or externally.

8. The process of claim 1, wherein the liquid or slurry is pre-heated to a temperature below the hydrate dissolution temperature before being introduced to the vessel.

9. The process of claim 1, wherein the liquid is pH neutral.

10. The process of claim 1, wherein the liquid has a specific gravity at least 20% greater than that of the hydrate.

11. The process of claim 1, wherein the liquid is insoluble in water.

12. The process of claim 4, wherein the liquid used to form the slurry has a different composition to the liquid introduced to the vessel.

13. The process of claim 1, further comprising a shut-down sequence including the step of substantially filling the vessel with a liquid so as to displace liberated gas from the vessel whilst maintaining the operating pressure of the vessel at or above the pre-set delivery pressure.

14. The process of claim 4, further comprising the step of balancing the supply of slurry to the vessel with the removal of liberated gas, liquid and free water from the vessel at the pre-set delivery pressure.

15. The process of claim 1, wherein the liquid introduced to the vessel or used to form the slurry is water, condensate, LPG or a combination thereof.

16. The process of claim 1, further comprising the step of conditioning the released gas by adjusting the temperature of the gas.

17. The process of claim 1, further comprising the step of separating excess water from the released gas.

18. The process of claim 1, further comprising the step of separating excess liquid and/or slurry-forming liquid from the released gas.

19. The process of claim 18, further comprising the step of recycling at least a portion of the separated excess liquid and/or slurry-forming liquid.

20. The process of claim 1, further comprising the step of agitating the hydrates in the vessel.

21. The process of claim 20, wherein the step of agitating comprises the step of introducing the liquid tangentially to the vessel so as to create a vortex.

22. The process of claim 1, further comprises the step of removing a mixture of free water, liquid and/or slurry-forming liquid from the vessel.

23. The process of claim 22, further comprising the step of recovering gas from the mixture by reducing the pressure of the mixture so as to produce a supersaturated mixture and subjecting the supersaturated mixture and hereafter separating gas from the supersaturated mixture.

24. The process of claim 23, further comprising the step of compressing the separated gas to the pre-set delivery pressure.

25. An apparatus for producing a gas at a pre-set delivery pressure, the apparatus comprising:
a sealable vessel to receive hydrates;
a liquid inlet to introduce a liquid to the sealable vessel;
a means for dissolving at least a portion of the hydrates; and,
a gas outlet arranged to release the liberated gas from the vessel when the operating pressure of the vessel is at or above the pre-set delivery pressure.

26. The apparatus of claim 25, further comprising a slurry inlet to receive a slurry comprising a slurry-forming liquid and hydrates.

27. The apparatus of claim 25, wherein the means for dissolving at least a portion of the hydrates comprises a means for heating the hydrates to a temperature greater than the hydrate dissolution temperature.

28. The apparatus of claim 27, wherein the means for heating the hydrates comprises a heating unit internal or external to the vessel.

29. The apparatus of claim 25, further comprising a controller to balance the supply of slurry to the vessel with the removal of at least one of liberated gas, slurry-forming liquid, liquid and free water from the vessel so as to maintain the operating pressure of the vessel at the pre-set delivery pressure.

30. The apparatus of claim 25, wherein the sealable vessel comprises a plurality of sealable vessels operating in series or parallel.

31. The apparatus of claim 25, further comprising a gas conditioning unit to adjust the released liberated gas.

32. The apparatus of claim 31, further comprising a means of removing water from the released liberated gas.

33. The apparatus of claim 25, further comprising a gas/liquid separator to separate excess liquid and/or slurry forming liquid from the released gas.

34. The apparatus of claim 25, further comprising an agitator to agitate the hydrates in the vessel.

35. The apparatus of claim 25, wherein the liquid inlet is tangential to the vessel.

36. The apparatus of claim 33, further comprising a gas recovery unit to recover gas from at least one of a mixture of free water, liquid and slurry-forming liquid drained from the vessel.

37. The apparatus of claim 36, wherein the means for recovering gas form the separated excess free water and/or liquid comprises one or more condensers for reducing the pressure of the recovered gas and produce a supersaturated gas.

38. The apparatus of claim 37, further comprising one or more gas/liquid separators to separate gas from the supersaturated gas.

39. The apparatus of claim 38, further comprising one or more compressors to compress the separated gas so as to increase the pressure of the separated gas.
